(19) United States
(12) Patent Application Publication
(10) Pub. No.: US 2002/0128958 A1
(43) Pub. Date: Sep. 12, 2002

(54) International trading of securities

(76) Inventor: Jonathan Slone, New York, NY (US)

Correspondence Address: SHEARMAN & STERLING, INTELLECTUAL PROPERTY DOCKETING, 599 LEXINGTON AVENUE, NEW YORK, NY, 10022, US

(21) Appl. No.: 10/085,552

(22) Filed: Feb. 28, 2002

Related U.S. Application Data
(60) Provisional application No. 60/272,152, filed on Feb. 28, 2001.

(51) Int. Cl. G06F 17/60

(52) U.S. Cl. 705/37; 705/36

(57) ABSTRACT

Securities dealers in at least three countries arrange an alliance. The securities dealers agree to share securities research among each other. Each dealer agrees to provide trade execution services in a securities market in the dealer's country to clients of the other dealers of the alliance. Each dealer guarantees settlement of any trade agreed in the market in the dealer's country. Each dealer agrees to act as custodian for securities traded on a securities market in the dealer's country on behalf of clients of the other dealers in the alliance. A hub entity may provide a computer system for managing the sharing of research and for routing messages among the dealers to implement trades.

### CROSS REFERENCE TO RELATED APPLICATION

This application claims the benefit of United States Provisional Patent Application No. 60/272,152, filed Feb. 28, 2001, entitled International Trading of Securities, which is hereby incorporated by reference herein in its entirety.

### BACKGROUND OF THE INVENTION

The invention relates to an arrangement for automated financial or business practices.

It is known for a securities broker in one country to enter a bilateral agreement with a securities broker in another country, under which one of the brokers will execute trades in the securities markets in its own country on behalf of the other broker's clients.

### SUMMARY OF THE INVENTION

In general, in a first aspect, the invention features a method. Securities dealers in at least three countries join an alliance. The allied securities dealers agree to share securities research among each other and to execute trades on behalf of each other's clients in markets in the respective countries. A computer system may be provided, programmed to share securities research data among the three dealers, and to allow each dealer to initiate securities trades in a market in the countries of the other dealers.

In general, in a second aspect, the invention features a method. Securities dealers in at least three countries agree to join an alliance. Each dealer agrees to provide trade execution services in a securities market in the dealer's country to clients of the other dealers of the alliance. Each dealer guarantees settlement of any trade agreed in the market in the dealer's country.

In general, in a third aspect, the invention features a method. Securities dealers in at least three countries agree to join an alliance. Each dealer agrees to act as custodian for securities traded on a securities market in the dealer's country on behalf of clients of the other dealers in the alliance.

In general, in a fourth aspect, the invention features a computerized system having connections to three securities dealers in three countries. The computer system is programmed to allow each dealer to initiate securities trades in a market in the countries of the other dealers, and to maintain a custodial account at each of the securities dealers for securities traded on a securities market in the dealer's country on behalf of clients of the other dealers.

Preferred embodiments of the invention may include one or more of the following features. The alliance may include a hub entity, independent of at least most of the allied securities dealers. The hub entity may contract to provide computer infrastructure designed to implement the research sharing and trade execution among the allied securities dealers. The hub entity may further contract to provide a central computer memory from which the allied securities dealers may retrieve the shared research, and to provide a central routing service designed to implement the trade execution among the allied securities dealers. The computer infrastructure may be designed to validate a trade requested by a client of one of the allied securities dealers for compliance with market rules of the exchange on which the security is to be traded. The computer infrastructure may be further designed to generate messages to the allied securities dealers to implement trade execution from order receipt to either completion or referral to an exception mechanism. The hub entity may further contract to provide computer infrastructure to settle and clear trades executed by one of the allied securities dealers on behalf of clients of the other allied securities dealers. The hub entity may further contract to provide computer infrastructure for currency conversion for trades executed by one of the allied securities dealers on behalf of clients of the other allied securities dealers. The allied securities dealers may agree to provide quotes for clients of the other allied securities dealers. The alliance may include a settlement bank. Each dealer's guarantee may be an absolute obligation with no defenses. The hub entity may act as counter-party for trades among the allied securities dealers, and guarantee settlement of any trade to which it is party-party. The hub entity may contract to make a market in at least some of the securities traded by the allied securities dealers.

The above advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

FIG. 1 is a block diagram of a network of relationships among brokers and a Securities Trading System.

FIGS. 2a, 2b and 2c are block diagrams of computer systems for a Securities Trading System.

### DETAILED DESCRIPTION OF THE PREFERRED EMBODIMENTS

### I. Overview

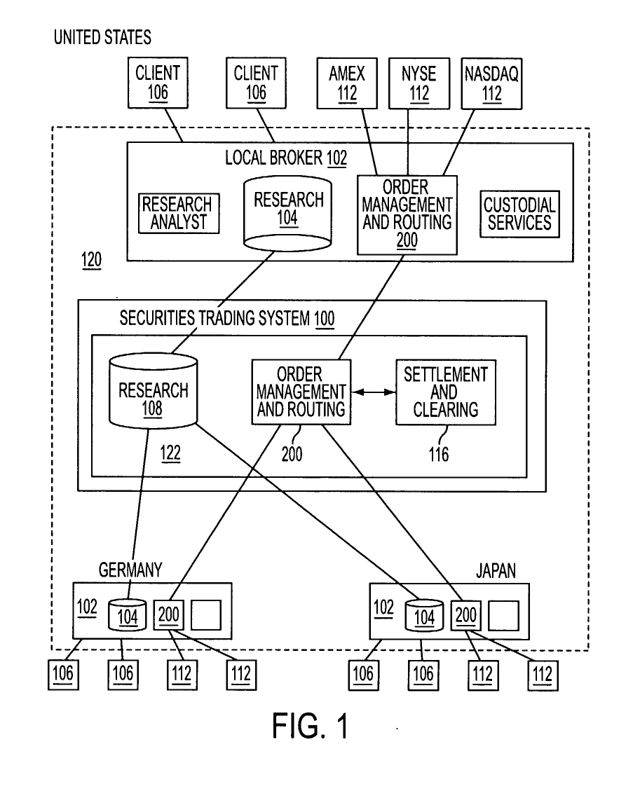

Referring to FIG. 1, securities Trading System 100 provides a common platform for sharing of resources among securities brokers 102. Securities Trading System 100 may tsar provide Local Brokers 102 access to each other's research products 104, quotes, other market information, and other types of content, such as news services and news commentary. Securities Trading System 100 may provide this information 104 to Local Brokers 102 in a form that enables the Local Brokers 102 to customize the presentation of that information 104, and to integrate the information into their own networks to complement existing products, for use by their own clients 106 in their own local trading venues 112. Securities Trading System 100 may provide each Local Broker 102 with access to many of the same information resources of brokers operating in each country represented among the membership. Securities Trading System 100 may enable the Local Broker 102 to deal in foreign trading venues 112 by providing a live-time connection to either a national market system 112 and/or other source of liquidity. In turn, using Securities Trading System 100, Local Brokers 102 may provide their clients 106 with access to trading of securities in foreign trading venues 112, and the execution abilities of Local Brokers 102 in the respective markets 112. Clients 106 of the Local Brokers 102 may have the capability to trade seamlessly in a foreign market 112 with essentially the ease of trading in their home markets 112.

Securities Trading System 100 may provide a number of different services to Local Brokers 102 through its network interfaces. Local Brokers 102 may in turn provide access to these services to internal employees (such as financial consultants, analysts, or sales force) over a private network or to clients 106 over a public network. Services provided to clients 106 may include access to content, access to trading facilities, access to news, and/or access to quotes. In addition to the ability to trade, Securities Trading System 100 may provide the ability to settle and clear business in the local currencies of the traders. Securities Trading System 100 may provide these services at a variety of service levels.

Securities Trading System 100 may provide a common storage point 108 for all Local Brokers 102 to store their research 104. Securities Trading System 100 may provide an access point through which other Local Brokers 102 may access the research 104 of other Local Brokers 102 in their specific markets 112. For example, a U.S. Local Broker 102 may be able to design its web site with links into the research 104 archive for stocks in Italy and stocks in France, provided by Local Brokers 102 in Italy and France. A client 106 of the U.S. Local Broker 102 dealer may have access to a number of international securities trading capabilities provided on the web site of the U.S. Local Broker 102. The client 106 may obtain a menu list of countries, or stocks from various countries. If Securities Trading System 100 has Local Brokers 102 in France, Germany, the U.K., and Japan, each contributing information, then the U.S. Local Broker 102 may present the information on his own web site in any form that he believes will be convenient for his American clients 106. Depending on the features made available by the U.S. Local Broker 102, and the form in which the U.S. Local Broker's web site makes the information available, the U.S. client 106 may be able to draw research content, news, commentary, quotes, etc. 104 from any one of these markets 112. Depending on the capabilities provided by the U.S. Local Broker 102, the client 106 may be able to obtain research on an industrial sector, for example automobiles, and obtain research 104 on and trade securities of all auto companies, regardless of the market 112 in which each company's stock trades.

Securities Trading System 100 may include an order management system 200. As a client 106 places a trading order, Securities Trading System 100 may verify the order, for example to confirm the security to be traded, and that the lot size and type of trade are acceptable to the market or exchange 112 on which the security is traded. For example, for a security trading on a Japanese exchange 112, Securities Trading System 100 may require that a short sale be executed at the last trade's price; for a security trading on a U.S. exchange 112, Securities Trading System 100 may enforce the U.S. down tick rule. (The “downtick rule,” also known as the “up tick rule,” is rule applicable to short sales, enforced by some exchanges. A short sale cannot be executed at or below the last price for the stock; the short sale must be at a price above the last trade in the stock. In another variation of the rule, a short sale is forbidden on stocks whose last trade was lower than the previous trade.)

Securities Trading System 100 may have the ability to either make a market in a security or to transmit a trade to a Local Broker 102 or other third party broker-dealer to effect good delivery of securities and/or good delivery of cash on the trade. Securities Trading System 100 may offer twenty-four hour trading by acting as counter-party to any Local Broker 102. For example, a U.S. Local Broker 102 may receive an order for a trade in Italy. This trade may be executed with Securities Trading System 100 as counter-party, rather than the Italian Local Broker 102 or an Italian client 106. Vice-versa, the Italian Local Broker 102 may receive an order for a U.S. security; this trade may execute with Securities Trading System 100 as counter-party, not the U.S. Local Broker. In some cases, Securities Trading System 100 may pass those orders through to Local Brokers 102 to local stock exchanges 112 or, perhaps, send them to the trading desk of a Local Broker 102 for execution.

Securities Trading System 100 may provide foreign exchange services, so that Local Brokers 102 and their clients 106 may execute their trades in their home currencies. For example, a U.S. client 106 may be able to order an equity transaction in Italy and an equity transaction in Spain, and Securities Trading System 100 may perform all currency translations and conversions so that the entire transaction appears to have been executed in U.S. dollars.

Securities Trading System 100 may provide a settlement and clearing service 115. Settlement and clearing service 116 may manage the messaging and transfers of money and securities incident to clearance and settlement of a transaction once it has been consummated. Messages may be sent to a Local Broker 102 to take money out of the client's account, and the message may indicate the destination account for the funds. The destination account for the counter-party may be Securities Trading System 100, or one of the Local Brokers 102, and that Local Broker 102 may or may not have been involved in executing the trade. The settlement and clearing service 116 may arrange foreign exchange forward contract, which may allow Securities Trading System 100 to deliver local currency, where necessary on settlement date to consummate the trade.

### II. Contractual Relationships

II.A Membership and Infrastructure

Securities Trading System 100 may enter into agreements with a number of Local Brokers 102, settlement banks, and other financial institutions. For purposes of this disclosure, these may collectively be referred to as “strategic partners.” This collection of agreements may provide Local Brokers 102 with easier access to cross-border relationships with other brokers and settlement banks. Rather than negotiating individual bilateral agreements with individual brokers and settlement banks, a Local Broker 102 may join Securities Trading System 100 and obtain access to research 104 and execution services in a number of countries.

For purposes of this disclosure, the collection of alliances between Securities Trading System 100 and its strategic partners, together with the computer network thereby assembled, may be referred to as a “Securities Trading Network 120.”

In a contract between Securities Trading System 100 and a Local Broker 102, the Local Broker 102 may covenant to create and develop an interface between the Local Broker's systems and Securities Trading Network 120 so as to enable the provisioning, display and full functionality of all services to be provided by Local Broker 102 in order to meet the objectives of the Securities Trading Network 120.

II.B Obligations of Securities Trading System

Securities Trading System 100 may create, develop, operate and maintain a central communication and processing hub 122 for Securities Trading Network 120, including developing, operating and maintaining all communications interfaces with other strategic partners and providing technical assistance that relates to the systems or technology underlying Securities Trading System 100. Securities Trading System 100 may provide each Local Broker 102 with communication protocols that will enable the Local Broker 102 to contribute and access the information 108 and trading services 200, 116. Securities Trading System 100 may covenant to provide some agreed level of assistance and trading capabilities for Securities Trading Network 120, for example, 24-hour support, or support at any time that any market 112 is open. Securities Trading System 100 may indemnify the strategic partners for breach of its representations, warranties and covenants.

Securities Trading System 100 may covenant to execute, clear and settle all purchase and sale orders for securities received from the Local Broker and accepted by Securities Trading System 100. Securities Trading System 100 may covenant to execute all such orders on a “best execution” basis and in accordance with accepted industry standards. Securities Trading System 100 may covenant to serve as a universal counter-party for all trades over Securities Trading Network 120. Securities Trading System 100 may covenant to provide Local Brokers 102 with execution services in securities of those issuers offered by any Local Broker 102, or equity securities of any and all other issuers that are routed to Securities Trading System 100, either free or charged on a net fee basis and, if so requested by Local Broker 102, executed in its local currency.

Securities Trading System 100 may consult with each strategic partner to determine the minimum level of research, commentary and analysis 104 relating generally to the strategic partner's market 112 to be prepared by the partner, and the minimum number of securities to be made available to Securities Trading System 100 for such partner's market 112. Securities Trading System 100 may covenant to make available on its own servers for use by Local Broker 102, a standard package of market-related data and information relating to the markets 112 of the other Local Brokers 102, and may covenant to provide different levels of such data for different prices.

Securities Trading System 100 may covenant to promote Securities Trading Network 120 through advertising, media and its own website. Securities Trading System 100 and Local Broker 102 may implement a disaster recovery plan, to provide a back-up system in the event of a failure of all or part of Securities Trading Network 120. Securities Trading System 100 may insure losses resulting from unforeseen events that affect Securities Trading Network 120. The cost for such insurance may be raised by assessing a per-trade charge on each transaction occurring on Securities Trading Network 120.

II.C Obligations of Local Brokers 102 with Respect to Initiating Orders

The strategic partners may contractually agree to bind themselves to quality and content controls and standards. These standards may be negotiated between Securities Trading System 100 and the strategic partners, or may be unilaterally determined by Securities Trading System 100. Each strategic partner may contractually bind itself to communicate to Securities Trading System 100 notice of any material change in any law, rule or regulation of any governmental agency or regulatory body in the strategic partner's market 112 that would affect the quality and content controls and standards.

Each Local Broker 102 may covenant to make the services and information provided by Securities Trading System 100 available and accessible to its clients 106 worldwide. Each Local Broker 102 may covenant to provide a specified minimum number of trade orders quarterly.

Each Local Broker 102 may covenant to route to Securities Trading Network 120 for execution all order flow of the Local Broker's clients 106 that are to be executed on trading venues 112 outside the Local Broker's own market 112. Each Local Broker 102 may covenant to, at the Local Broker's discretion, obtain retail order flow from sources in addition to the Local Broker's client base for execution on Securities Trading Network 120 The Local Broker may covenant to route such orders to Securities Trading System 100 immediately upon receipt and acceptance thereof by the Local Broker. The Local Broker may covenant not to delay routing accepted orders to Securities Trading System 100 for the purpose of bundling or aggregating individual orders or otherwise.

Each Local Broker 102 may covenant to ensure full compliance with all laws, rules and regulations applicable to Securities Trading Network 120. Each Local Broker 102 may covenant to make Securities Trading Network 120 available and accessible to all of the Local Broker's clients 106 who are eligible or permitted by law, rule or regulation to trade in equity securities in networked trading venues 112.

Each Local Broker 102 may covenant to promote Securities Trading System 100 through advertising, media, its website and branding.

II.D Obligations of Local Brokers 102 with Respect to Order Execution, Clearance, and Settlement in the Local Broker's Local Market(s)

Each Local Broker 102 may covenant to make available to and through Securities Trading System 100 brokerage services for designated securities in the Local Broker's market 112. Each Local Broker may covenant to execute, clear and settle all purchase and sale orders for securities received from Securities Trading System 100. The Local Broker may covenant to execute all such orders on a “best execution” basis and in accordance with accepted industry standards. The Local Broker may covenant to provide execution at a price that at the time of execution is equal to the clearing price of the security on the principal stock exchange 112 or automated quotation system located in the Local Network Market 112 in which the security is principally traded. Each Local Broker 102 may further covenant to serve as executing broker for such trade orders at a reasonable service level and standard to be determined by Securities Trading System 100. Each Local Broker 102 may further covenant that all limit orders routed by Securities Trading System 100 to the Local Broker will be routed by the Local Broker to an exchange 112 for execution. Each Local Broker 102 may covenant to act as counter-party for certain trades that are routed by the Local Broker 102 to Securities Trading System 100.

Each Local Broker 102 may covenant to provide Securities Trading System 100 with a license to use the research 104 relating to companies in its home market 112, including the right to sublicense the use of such research 104, commentary and analysis to the other strategic partners.

Each strategic partner may obligate itself to provide and maintain a custodial account on behalf of Securities Trading System 100 and the other strategic partners. Strategic partners may indemnify the other strategic partners and Securities Trading System 100 for breach of representations, warranties and covenants. Each Local Broker 102 may covenant to purchase and maintain any necessary hardware, software and/or communications interfaces and services required to support the information and trading functions of Securities Trading System 100.

II.E Reciprocal Obligations of Guaranteed Settlement

On the settlement date of a purchase order executed by Securities Trading System 100 on behalf of a Local Broker, the Local Broker may be under a guaranteed obligation to deliver the purchase price of the purchased securities to or at the direction of Securities Trading System 100, without asserting defenses of any kind, and Securities Trading System 100 may be under a guaranteed obligation to deliver the purchased securities to or at the direction of the Local Broker, without asserting defenses of any kind. On the settlement date of a sale order executed by Securities Trading System 100 on behalf of the Local Broker, the Local Broker may be under a guaranteed obligation to deliver the sold securities to or at the direction of Securities Trading System 100, without asserting defenses of any kind, and Securities Trading System 100 may be under a guaranteed obligation to deliver the purchase price of the sold securities to or at the direction of the Local Broker, without asserting defenses of any kind.

On the settlement date of a purchase order executed by a Local Broker on behalf of Securities Trading System 100, Securities Trading System 100 may be under a guaranteed obligation to deliver the purchase price of the purchased securities to or at the direction of the Local Broker, without asserting defenses of any kind, and the Local Broker may be under a guaranteed obligation to deliver the purchased securities to or at the direction of Securities Trading System 100, without asserting defenses of any kind. On the Settlement Date of a sale order executed by the Local Broker on behalf of Securities Trading System 100, Securities Trading System 100 may be under a guaranteed obligation to deliver the sold securities to or at the direction of the Local Broker, without asserting defenses of any kind, and the Local Broker may be under a guaranteed obligation to deliver the purchase price of the sold securities to or at the direction of Securities Trading System 100, without asserting defenses of any kind.

II.F Obligations of Local Brokers 102 with Respect to Research 104

Each Local Broker 102 may covenant to make available, on a timely basis, to Securities Trading System 100 and the other strategic partners a minimum level of research with respect to certain securities traded in the partner's home market 112. For example, the Local Broker 102 may commit to make available research 104 of a particular quality with respect to the top 30% (or some other number) of companies listed on the primary exchange 112 in the broker's home country, and other customary market commentary and analysis relating generally to Local Broker's market 112, in each case as prepared by qualified representatives of Local Broker 102. The Local Broker 102 may not be obligated to provide research 104, commentary and analysis with respect to issuers not covered by Local Broker 102.

Securities Trading System 100 may define standards for the information to be provided. Such standards may be defined with respect to regulatory requirements, and Local Brokers 102 may be required to run their information against a checklist of requirements before being allowed to upload information to Securities Trading System 100. For example, Securities Trading System 100 may impose requirements on all Local Brokers 102 worldwide that reflect the requirements of U.S. securities regulations, for example, that a broker be able to demonstrate that a report provided by that broker was carefully written, and that it does not make false statements.

Securities Trading System 100 may include a manual of requirements binding on all Local Brokers 102, specifying a standard for quality of research 104 that may be suitable for investors in all markets 112 in which Securities Trading System 100 has Local Brokers 102. For example, Securities Trading System 100 may develop an international standard for disclosure, by finding the most-demanding standard in each jurisdiction in which Securities Trading System operates. Securities Trading System may then educate each Local Broker 102 in that standard. This standard may be enforced by contract among the Local Brokers 102 and between Securities Trading System 100 and its Local Brokers 102, so that research reports 104 provided by Local Brokers will meet the regulatory standards of all jurisdictions.

Local broker 102 may covenant that the research reports 104 contributed to Securities Trading System 100 and the other strategic partners are to be prepared and/or provided in accordance with applicable law, rules, regulations and other requirements to be met under the Local Broker's own local regulatory regime, and that they meet the standards approved by Securities Trading System 100.

Each Local Broker may covenant that any research reports 104 provided are the “best available research” relating to the relevant issuer, and are to be provided to Securities Trading System 100 not later than when such research report is first made available to any other client 106 of Local Broker 102.

Securities Trading System 100 and the strategic partners may mutually covenant not to disseminate any communication that contains (i) any untrue statement or omission of a material fact or is otherwise false or misleading; (ii) promises of specific results, exaggerated or unwarranted claims; (iii) opinions for which there is no reasonable basis; or (iv) projections or forecasts of future events which are not clearly labeled as forecasts.

Each strategic partner may covenant to designate one of its employees as its Designated Analyst. The Designated Analyst will have primary responsibility for enforcing guidelines established by Securities Trading System 100. Each strategic partner 102 may covenant that its Designated Analyst will review any research reports 104 prepared by the respective strategic partner before the research report is disseminated to Securities Trading System 100 or any other person, including to any other strategic partner or to clients 106 or other individuals outside of Securities Trading Network 120. The Designated Analyst may be required to ensure that the research reports 104 provided by the strategic partner are based on adequate independent investigation and that statements made therein are made with a reasonable basis for believing the statements therein to be accurate.

Each Designated Analyst may be required to ensure that each research report 104 provided by its strategic partner meets the following requirements: (a) a recommendation (even though not labeled as a recommendation) in a research report 104 must have a basis that can be substantiated as reasonable. (b) When recommending the purchase, sale or switch of specific securities, supporting information must be provided or offered. (c) The market price at the time the recommendation is made must be indicated in the research report 104.

When a research report 104 (excluding extemporaneous interviews in and with the media) recommends the purchase or sale of a specific security, the report may also specifically disclose: (a) whether the strategic partner usually makes a market in the security being recommended or if some or all of the recommended securities are to be sold to or bought from customers on a principal basis; (b) whether the strategic partner was manager or co-manager of the most recent public offering (within 3 years) of any securities of the recommended issuer; (c) other potential conflicts of interest, including preparation of previous communications of the issuer, co-ownership, options or other equity positions in the issuer, directorships in the issuer, etc. Any projection or prediction may be required to state the bases or assumptions upon which they are made and may be required to indicate that the materials upon which such projections and predictions are made are available upon request. All research reports 104 may be required to be appropriately dated. Any significant information that is not reasonably current (usually more than 6 months old, depending upon the industry and the circumstances) may be required to be noted. The strategic partner may covenant to retain all underlying materials (including notes of any meetings or calls with company management and any other back-up material) for three years. Each strategic partner may covenant to maintain on file for seven years copies of all research reports 104 provided.

The strategic partner may be required to indicate its name on the cover page of all research reports 104 it provides to Securities Trading System 100. If the strategic partner is not the preparer of the research report 104, the name of the preparer of the research report 104 may be required to be clearly displayed on the cover page of the report.

Research reports 104 may feature records or statistics that portray the performance of past recommendations or the performance of actual transactions, provided that the portrayal is balanced, includes the effects of commissions and other costs, and adequately supported by verifiable statistical facts. Any comparison of one strategic partner's service, personnel, facilities or charges with those of other firms may be required to be factually supportable.

Securities Trading System 100 may require that all research reports 104 be in English, and that they contain a standard “hedge clause” warning the reader of the limitations of the research report.

Securities Trading System may define a standard scoring system for securities, to facilitate comparison among the securities. For example, an Investment Risk Rating may be assigned, having values of Low Risk, Average Risk, Above Average Risk, or High Risk. The risk/volatility of a particular stock can be affected by, among other factors, the local market 112 in which the stock trades. For example, a stock trading in an “emerging market” can be expected to entail an additional element of risk which will be reflected in the Investment Risk Rating. Securities Trading System 100 may provide specific definitions for each Risk Rating, taking into account the expected share volatility, earnings history, strength of management, balance sheet, and strength of the issuer in its industry. An Appreciation Potential may be ranked as Buy, Accumulate, Hold, Neutral, Reduce, or No Rating. An Appreciation Potential Rating may be Intermediate-term (0-12 months) or Long-term (more than 12 months). An Income Rating may project an expected dividend/distribution in relation to the current payment, and may be stated as Same/Higher, Same/Lower, No Cash Dividend, or Under Review.

II.G Miscellaneous Provisions

Strategic partners may opt not to provide access to Securities Trading System 100 to certain clients 106, if those clients live in designated countries outside the strategic partner's own country. For example, a Local Broker 102 in the U.S. may opt not to provide to its clients that reside in France research or other content 104 received from Securities Trading System 100. Similarly, this U.S. Local Broker 102 may opt not to accept orders from its clients 106 that live in France for execution over Securities Trading System 100. If the strategic partner later commences operations in a country not previously served, the strategic partner may have an option to opt into that country with respect to clients that live in that country, or may be contractually obligated to opt those clients in.

Strategic partners may opt out of certain markets 112, not to trade on its own local market 112 on behalf of orders received from the opted-out market, and/or not to accept orders from its own clients 106 for execution in the opted-out local market. If a Local Broker 102 opts out of a certain market 112, the Local Broker 102 may be required to not make available research 104 obtained from Securities Trading System 100 in the opted out country. For example, a Local Broker 102 in the U.S. may opt not to accept orders from its clients 106 for trades in Libya, but the U.S. Local Broker 102 would then be required not to make Libyan research available to its clients 106.

The indemnities may contain limitations on liability, for example with respect to indirect or consequential damages, or provide for offset of damages by any insurance proceeds.

Securities Trading System 100 may agree with some strategic partners on constraints on whom it may accept as other strategic partners. For example, Securities Trading System 100 may agree not to contract with certain classes of competitors, without the prior consent of a specific strategic partner. For example, Securities Trading System 100 may agree not to allow a broker to become a Local Broker 102 unless it is one of the top five brokers in its market, or may set a maximum world-wide number of members, such limit not to be exceeded without the approval of the existing members. Constraints of this type may not be imposed on early strategic partners, and may become progressively demanding as the membership increases.

The agreements among the parties may specify ownership and licensing of pre-existing intellectual property, modifications and developments, and the research and other information 104. Strategic partners may retain ownership of all data and information supplied to Securities Trading System 100. Securities Trading System 100 may own all data an information generated by or supplied by its systems. For example, pre-existing intellectual property may remain in its original owner, while improvements may be owned by Securities Trading System 100, or may be jointly owned between the parties as the parties agree. The strategic partners may grant Securities Trading System 100 a license to sub-license research data and products to other strategic partners in networked markets 112 and to modify such research and data 104. Securities Trading System 100 may covenant to grant to Local Broker 102 a non-exclusive license to use software, systems, and information.

The parties may agree to fee arrangements. For example, a Local Broker 102 may pay a fixed fee of $5 or some other amount to Securities Trading System 100 for each trade executed on behalf of one of the broker's clients 106 over Securities Trading System 100. The Local Broker 102 that executes a trade may charge a per-trade fee, or a cost-plus fee. There may also be a fee associated with foreign currency exchange transactions. For free or at a base fee, Securities Trading System 100 may allow a Local Broker 102 access to a base level of information, for example to news and commentary. For incremental fees, Securities Trading System 100 may allow a Local Broker 102 access to incremental amounts of information, such as quotes, and/or filters to allow the Local Broker 102 to search and filter the news of interest.

The parties may agree to exclusivity and non-competition provisions. Each Local Broker 102 may agree not to participate in any other competing or similar network.

II.H Multilateral Agreements Among all Parties

The parties may enter a mutual confidentiality agreement. The parties may limit liability to each other to only losses arising from fraud, willful misconduct or gross negligence (to the degree that such limits on liability are enforceable in respective jurisdictions). The parties may agree to indemnify each other for losses arising from breach of any covenant, representation or warranty. The parties may agree to specific procedures for resolving inter-party claims and indemnification. The parties may agree to arbitration.

### III. Technological Interconnections

III.A Overview

Securities Trading System 100 may be implemented largely as an integration of a number of existing technologies. By integrating technologies and performing some systems integration, a new capability arises, that may create a trans-national ECN (Electronic Communication Network, a class of order matching systems that is less-organized and less-regulated than a conventional exchange 112).

The overall model for the computing facilities of Securities Trading System 100 may be a central processing and clearing site, that automates most of the collection, routing, and management of information, transaction execution, and other messages.

Securities Trading System 100 may include a routing platform, including a database, that follows the trades through to ensure completion of all requisite steps. Securities Trading System 100 may include trade logic for each individual market 112. Securities Trading System 100 may include a decision-making and routing component that decides where a trade should go and how that trade should be executed. Such decisions may include deciding whether Securities Trading System 100 should execute the trade that as a principal, as an agent, or whether the trade should be forwarded to a Local Broker 102 for execution by that broker.

III.B Order Management and Routing System Architecture

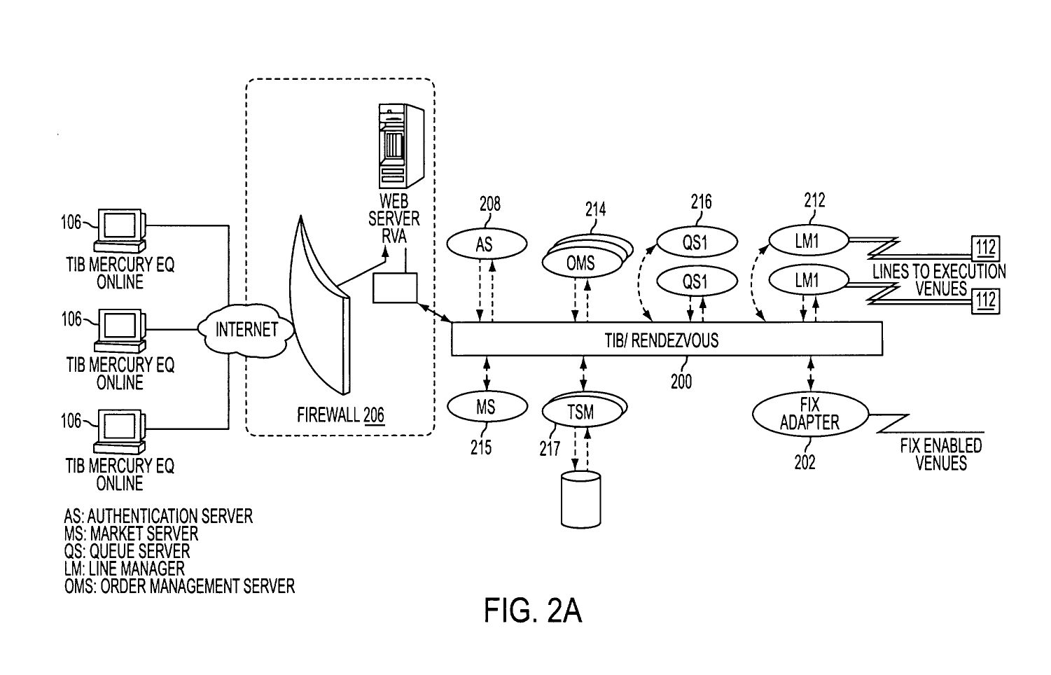

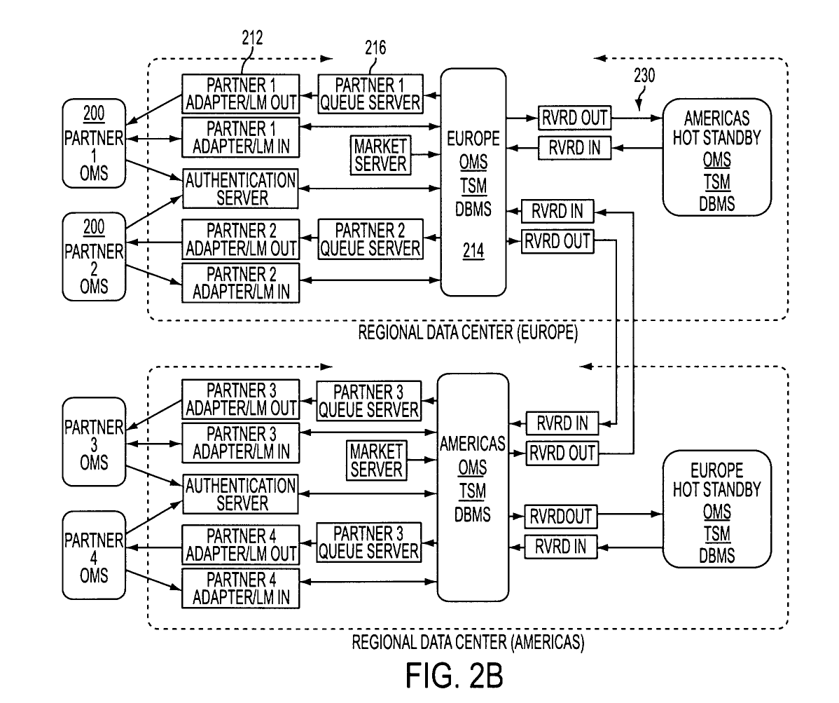

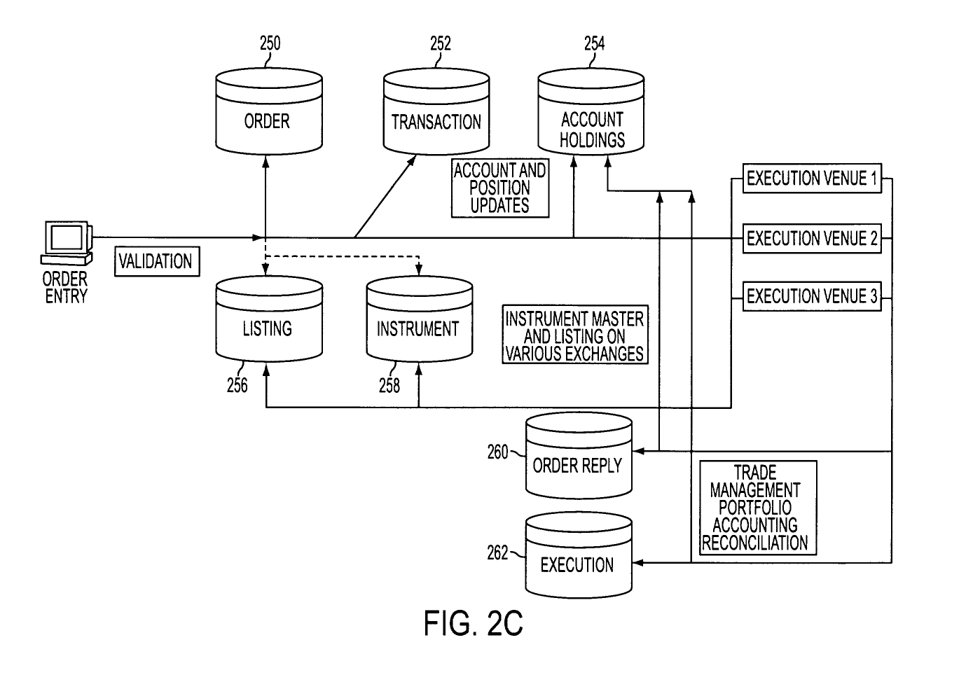

Referring to FIGS. 2a and 2b, one Local Broker's order and routing system 200 serves as an interface between the Local Broker's clients 106, markets or exchanges 112, and Securities Trading Network 120 and the other Local Brokers 102. Clients 106 may connect to the Local Broker's order and routing system 200 over a fairly conventional trading and information access internet web interface 206. Much of this software may be based on TIBCO's Rendezvous software, and interconnections therewith.

A communications manager 202 may manage communications lines to Securities Trading System 100 and the other Local Brokers 102.

Authentication server 208 provides user authentication and session management. Authentication server 208 receives all user login requests. Once the user is validated, the user profile is retrieved from a database. The user profile determines what services are available to the user. Authentication server 208 also provides a unique session key to the front-end for each session; all subsequent service requests by the front-end contain that session key.

Line managers 212 manage connections to various execution venues 112, managing connections and session management, and translating messages between the internal format used by Securities Trading System 100 and the format used by each venue 112. Line managers 212 tend to be specific to particular execution venues 112. Typically, each Local Broker site 102 will have a line manager 212 to route orders to each venue 112 in its local market.

Order management server 214 contains business rules for processing different types of orders, and is responsible for order and trade management. Order Management Server 214 contains a cache of business objects, takes care of order validation against both market and user rules, handles transaction creation and order routing to the appropriate Queue server 216, and handles trade management. Multiple instances of the Order management server 214 may be run to handle a large number of users. Business objects such as Users, Transactions 252, Instruments 258, Accounts 254, and Positions are cached on request and while active. Some objects may be made permanently resident in the cache.

Market server 215 holds real time Instrument 258 market data, and cached information such as instrument status, currency cross rates, index data and market lending rates. Market server 215 fetches news and news stories from the TIBCO market data servers. Market server 215 may subscribe to data from multiple feed sources and may be configured to use different market data elements from different sources.

Queue server 216 queues orders and transactions based on the status of the market and segments within the market. Queue server 216 caches incoming orders from the Order management server 214 and sends the orders to the appropriate Line manager 212 to be delivered to the appropriate execution venue 112. As responses for the order are received in the form of confirmations and executions, Queue server 216 sends these to the appropriate order management server 214. Order management servers 214 sends the order to Queue Server 216, without regard to the market phase. Queue servers 216 queue orders until the appropriate market is open, and then sends the orders to the Line Managers 212.

Transaction service manager 217 interprets messages as service requests and applies them as database operations. Transaction service manager 217 supports replication of operations by allowing users to maintain identical data in the own database tables across multiple database sites. Transaction service manager 217 uses an asynchronous guaranteed store-and-forward mechanism for replication. Users are not affected if a remote system or network connection fails. Transaction service manager increases availability, reduces network traffic, simplifies application developments, and facilitates access to the databases and other client server applications.

Each Local Broker may provide redundant communications lines and hot standby backups for computation nodes and communication lines.

III.C Database Tables

Referring to FIG. 2c, an Order table 250 tracks information about an order, starting with the information entered by a user. An Order record is created when the user initially enters an order. This initial record will usually be kept unchanged. Each order is assigned a unique ID number. For buy orders, the booked price is stored. For limit orders, the limit price is stored, and the currency in which the ordered is to be settled is stored. The quantity or amount is stored. Order table 250 stores whether the order is to be executed pre-opening or at opening. Order table 250 stores the date of initial creation, the effective date on which the order is to be entered, and the date on which the order is to expire.

A Transaction table 252 stores a current snapshot of partner orders, starting from the time a user inputs an order into the system. Each Transaction row, when considered with the Order table 250, contains the current state of the order, including the filled quantity and the average price, etc. Each Transaction has an ID number assigned by Securities Trading System 100 and an order number assigned by the exchange, an average price, an indication of whether it is a buy or sell order, a status (e.g., Open, Held, Accepted, Partially Filled, Cancelled, Expired, Rejected), an indication of a commission to be charged, an error code, an indication of the instrument being traded (see Instrument Table 258, below), an indication of the venue 112 on which the trade will be executed, a total number of open cancel orders against this order, a total number of open change orders against this order, the total value of the order and the value accumlated so far (including commissions, etc.), a quantity of the order already filled and the quantity remaining open, and an indication of any reduction in the order due to rejection or cancellation.

A Transaction Journal table may be tailored by each Local Broker to suit local needs. Each transaction journal row may include a description, a price, a quantity, a settlement date, a trading symbol, and a date.

An Account table 254 contains account information for each user or strategic partner. Account table 254 stores fields like cash amount after sell/buy order, cash withdraw/deposit after the data up-load, initial cash, maximum cash withdrawal limit for each account, the total amount that has been booked for currently open buy orders, and a currency in which cash is held in the account.

Each execution may be validated—the quantity must not be zero or negative, the amount may not be higher than the original order amount, and the price may not below the limit price nor above the stop price. An invalid execution table tracks executions that fail the validation.

A Listing table 256 tracks the relationship between an instrument and the exchange 112 where the instrument is listed. Each row of Listing table 256 has a pointer to a row of Instrument table 258, and a pointer to a row of the venue table. Other information in Listing table 256 includes the trading symbol, closing price of the instrument on the venue 112, the currency in which the instrument trades, the ID numbers for several information feeds, lookup symbol, minimum lot size and minimum allowed trade, information relating to any suspension of trading, and minimum quantity of an instrument for a venue 112.

An Instrument table 258 tracks instruments such as equities, futures, options, bonds, mutual funds, warrants, rights, or certificates of deposit. For example, this table 258 may track the type and description of the instrument, the trading symbol, the strike price, expiration date and contract size of options, the primary market on which the instrument trades. Individual instruments may be tracked by CUSIP and ISIN code.

An Order Reply table 260 stores reply messages for an order from exchanges 112 and Queue Server 216. It may contain information like reduced quantity, execution quantity, and status of an order. Each reply is assigned a unique identifier, both by the Securities Trading System 100 and by the exchange, a code indicating whether the reply relates to a new order, a change, or a cancellation, and whether it is an acknowledgement, a rejection, etc., and a link to a row in Transaction table 252. The quantity of the order, after any change, is stored. If there was an error, a code for the error is stored. A string may indicate a message for the reply. The Order Reply table may store either the quantity of the order after reduction, or the amount by which the order is reduced, and/or the quantity remaining after this reply.

An Execution table 262 tracks executions, including the time of execution, the order number assigned by the exchange, the price and quantity agreed, and/or the quantity of the order remaining after this execution.

A message queue table is used by Queue Server to send messages to Line Manager 212. The message queue table stores a message ID, message status (queued, sent, done), message type (NewOrder, ChangeOrder, or CancelOrder), and message tag (NewOrder, ChangeOrder, or CancelOrder) and the queue server for each message, and the transaction ID assigned by Securities Trading System 100 and the order number assigned by the exchange to the transaction to which the message relates, and/or the ID of the line manager 212 that acknowledged the new order. This table is also used for internal recovery of each message.

A Market Phase table stores information about the each market phase for each exchange. For instance, for each phase of each exchange, the Market Phase table stores the open and close time for that phase of that market's day, and whether or not trading is allowed in the given market phase.

Other tables in the Order Management system may track cancelled orders, changed orders (where the number of shares is increased or decreased), commission rules used in respective markets, currency conversion rates and methods (including the market on which a given conversion is to be performed, commission information, and linkages among currencies—for instance among the currencies in the Euro zone), an event log to track password changes and other changes in execution powers, holidays, the portfolios of each user or strategic partner, routing and trading permissions of partners and groups, and trading venues 112 (describing each exchange or market, describing holidays, country, currency, time zone, and trading hours), and a number of tables for internal administration (such as load balancing, etc.)

III.D Data Communication Protocols

Securities Trading System 100 may provide access to its information and trading facilities in a way in which a Local Broker 102 could flexibly deploy it. For example, the information may be provided to a Local Broker 102 in a form that allows the Local Broker 102 to format the information for its own web page, for access over a wireless telephone, a Palm Pilot, etc. Securities Trading System 100 may provide a flexible “bus” to the information, that allows the information to be deployed in a number of different ways.

Strategic partners may receive information from Securities Trading System 100 in the form of HTML or a similar mark-up language. In this form, Local Brokers 102 may format and present the data to their clients 106 in a from chosen by the Local Broker 102, with relative independence from constraints imposed by Securities Trading System 100. Thus, the U.S. Local Broker's website for an Italian security may have a “look and feel” almost identical to the look and feel of the broker's website for a U.S. security.

Securities Trading System may define the contents of a ticket for each market 112. For example, for a ticket for a trade on the Italian market 112, Securities Trading System 100 may define a certain set of information to be supplied—the name of the stock, the share amount, and a few other attributes. For a ticket for a trade on the Frankfurt exchange 112, Securities Trading System 100 may specify a different set of information to be supplied. A Local Broker 102 may display the information of a ticket for a client 106 as the Local Broker 102 chooses.

The modularity of the presentation of the information may allow each Local Broker 102 to tailor the presentation of the information differently for different audience. The Local Broker 102 may present information in one form (and at one level of detail) to clients 106, and in another form and/or level of detail to in-house financial consultants.

Securities Trading System 100 may define a standard interface, for instance using XML (extensible markup language) that permits Local Brokers 102 to embed a market data delivery service into their financial applications. Examples of use may include (a) hosting a web site that includes a market data delivery capability, (b) automating the presentation of market data resulting from cross-border financial activity, (c) providing pricing for an on-line retail web site in foreign equities, and/or (d) incorporating a market data component in automated business-to-business transaction processing. Using the XML Interface, a Local Broker 102 may build a connection to the Securities Trading System 100 through which clients 106 may request and receive price quotes, execute deals and run reports.

The XML Interface may provide access to the features of Securities Trading System 100, including snap quotes, news, charts, and company profiles for a full range of market data quotations. The Interface also permits the end-consumer to request a list of quotations and the detail for any security that the end-consumer has transacted.

Though the primary design focus for the XML Interface is the Local Broker's remotely hosted web site, the XML Interface may also be well suited to constructing a computer-to-computer interface in which no user screens or manual intervention would be involved.

The XML Interface may provide (a) connectivity to multiple exchanges, (b) the integration and creation of customized templates based on standard HTML, using special tags and variables, (c) functions for different integrated market data for quotes, charts, and news, and (d) access to research databases.

The XML interface may provide services to obtain cross-rates among different currencies, a list of available currencies that may be selected, functions to add or delete information from a particular stock that a client 106 has on a watch list, access to market data for a given security, or to edit a client's preferences.

Encryption may be used to prevent external parties from comprehending intercepted network traffic. The XML Interface may be provided over the HTTPS transport protocol through the encryption capabilities of Secure Socket Layer (SSL).

The physical network between the client application and the Local Broker web site may be over the Internet or over a dedicated leased line. In the event of a leased line, further encryption may be employed in the form of hardware encryption devices. Regardless of this additional encryption, the client system may communicate HTTPS to the Local Broker's web server.

The XML Interface may use digital signatures to achieve non-repudiation. Individual user accounts may be registered as participating in the non-repudiation scheme, or not participating. For participating users, non-repudiation may be implemented using public-key/private-key techniques. Messages that are not signed or incorrectly signed may be blocked from being forwarded from the client to the Local Broker, from the Local Broker to Securities Trading System 122, etc., and may instead register an error. In the event of a dispute, the log can be scanned and the original signed XML message may be extracted to establish the intent of the client 106. The dispute management process may be implemented manually.

III.E Standards Definition

Securities Trading System 100 may define standards and a common communications protocol for computer interfaces among the strategic partners, to allow the strategic partner to inter-communicate with each other seamlessly. This common standard may be implemented as a layer on top of established protocols, for example, FIX (Financial Information Exchange), SWIFT (Society for Worldwide Interbank Financial Telecommunication), defined XML data tags, message formats, etc. In part, the common communications protocol may be provided as several gateways to existing message protocols. Securities Trading System may extend these protocols by defining a standard representation for other attributes, for example, price-to-eamings ratio, Investment Risk Rating, Appreciation Potential, Income Rating, etc.

In some embodiments, research 104 may be broken into parts and the parts given XML tags so that the Local Broker 102 may format the data for presentation. For example, there may be a tag for “Overview of a company's research,” for the different financial statements and discussions, footnotes, ratios, trading history, etc. In other embodiments, the system may treat research reports 104 as entire indivisible entities, delivered to the Local Broker 102 for the Local Broker 102 to display as he chooses.

III.F Software

Securities Trading System 100 may include messaging logic that generates messages to effect each trade. The messaging logic may be implemented as a list of the constituent steps underlying each action, and control logic to generate messages to implement each step. Each message may be tracked in a database. The database may record the message content, the sender, receiver, and status of the message, an action to be taken if no reply is received, an exception desk for handling an exception, and a protocol for handling the exception. The status may be drawn from a defined set of possible status values—for example, not yet ready to send, queued to be sent, sent and no reply is expected, sent and a reply is expected by time t, sent and a reply is overdue, or sent to an exception desk for manual processing.

Securities Trading System 100 may include a data warehouse 108 that centralizes all the data, including a real time quote server, a real time news server, and/or a real time research server. Quotes may be fed by a quote service. The news server may be fed by Local Brokers 102 and by various news services. The research server may be fed largely by the Local Brokers 102 and other strategic partners, who may have developed this research 104 independently of their membership in Securities Trading System 100.

Securities Trading System 100 may provide “back office” and settlement processing, possibly partially automated and partially manual. Generally, exceptions are processed manually. Back office processing is provided as a business-to-business piece to the Local Brokers 102.

Many of the software functions are available in industry standard software, for example provided by TIBCO or Brokat. Additional customization may be provided, for example order management 200, trade routing, trade matching, and a clearing and settlement module (that embodies rules of how markets are traded and settled).

A portion of the disclosure of this patent document contains material that is protected by copyright. The copyright owner has no objection to the facsimile reproduction of the patent document or the patent disclosure as it appears in the Patent and Trademark Office file or records, but otherwise reserves all copyright rights whatsoever.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

What is claimed is:

1. A method, comprising the steps of:
arranging an alliance among securities dealers in at least three countries, the allied securities dealers agreeing to share securities research among each other, each dealer agreeing to provide trade execution services in a securities market in the dealer's country to clients of the other dealers of the alliance, each dealer agreeing to guarantee settlement of any trade agreed in the market in the dealer's country, and each dealer agreeing to act as custodian for securities traded on a securities market in the dealer's country on behalf of clients of the other dealers in the alliance.

2. A method, comprising the steps of:
arranging an alliance among securities dealers in at least three countries, the allied securities dealers agreeing to share securities research among each other and to execute trades on behalf of each other's clients in markets in the respective countries.

3. The method of claim 2, further comprising the step of:
agreeing among the dealers that each dealer is to guarantee settlement of any trade agreed in the market in the dealer's country.

4. The method of claim 2, further comprising the step of:
agreeing among the dealers that each dealer is to maintain a custodial account for securities traded on a securities market in the dealer's country on behalf of clients of the other dealers.

5. The method of claim 2, further comprising the step of:
including within the alliance a hub entity, independent of at least most of the allied securities dealers, the hub entity contracting to provide computer infrastructure designed to implement the research sharing and trade execution among the allied securities dealers.

6. The method of claim 5, wherein the hub entity further contracts to provide a central computer memory from which the allied securities dealers may retrieve the shared research, and to provide a central routing service designed to implement the trade execution among the allied securities dealers.

7. The method of claim 6, wherein the computer infrastructure is further designed to validate a trade requested by a client of one of the allied securities dealers for compliance with market rules of the exchange on which the security is to be traded.

8. The method of claim 6, wherein the computer infrastructure is further designed to generate messages to the allied securities dealers to implement trade execution from order receipt to either completion or referral to an exception mechanism.

9. The method of claim 5, wherein the hub entity further contracts to provide computer infrastructure to settle and clear trades executed by one of the allied securities dealers on behalf of clients of the other allied securities dealers.

10. The method of claim 5, wherein the hub entity further contracts to provide computer infrastructure for currency conversion for trades executed by one of the allied securities dealers on behalf of clients of the other allied securities dealers.

11. The method of claim 2, further comprising the step of:
arranging among the allied securities dealers to provide quotes for clients of the other allied securities dealers.

12. The method of claim 2, further comprising the step of:
including within the alliance a settlement bank.

13. A method performed by a securities dealer in a first country, comprising the steps of:
joining an alliance with at least two other securities dealers, being dealers in second and third countries, respectively, the three securities dealers agreeing to share securities research among each other and to execute trades on behalf of each other's clients in markets in the respective countries.

14. The method of claim 13, further comprising the step of:
agreeing among the dealers that each dealer is to guarantee settlement of any trade agreed in the market in the dealer's country.

15. The method of claim 13, further comprising the step of:
agreeing among the dealers that each dealer is to maintain a custodial account for securities traded on a securities market in the dealer's country on behalf of clients of the other dealers.

16. The method of claim 13, further comprising the step of:
including within the alliance a hub entity, independent of at least most of the allied securities dealers, the hub entity contracting to provide computer infrastructure designed to implement the research sharing and trade execution among the allied securities dealers.

17. The method of claim 16, wherein the hub entity further contracts to provide a central computer memory from which the allied securities dealers may retrieve the shared research, and to provide a central routing service designed to implement the trade execution among the allied securities dealers.

18. The method of claim 17, wherein the computer infrastructure is further designed to validate a trade requested by a client of one of the allied securities dealers for compliance with market rules of the exchange on which the security is to be traded.

19. The method of claim 17, wherein the computer infrastructure is further designed to generate messages to the allied securities dealers to implement trade execution from order receipt to either completion or referral to an exception mechanism.

20. The method of claim 16, wherein the hub entity further contracts to provide computer infrastructure to settle and clear trades executed by one of the allied securities dealers on behalf of clients of the other allied securities dealers.

21. The method of claim 16, wherein the hub entity further contracts to provide computer infrastructure for currency conversion for trades executed by one of the allied securities dealers on behalf of clients of the other allied securities dealers.

22. The method of claim 13, further comprising the step of:
arranging among the allied securities dealers to provide quotes for clients of the other allied securities dealers.

23. The method of claim 13, further comprising the step of:
including within the alliance a settlement bank.

24. A computerized system, comprising:
a computer having connections to three securities dealers in three countries, respectively, the computer system being programmed to share securities research data among the three dealers, and to allow each dealer to initiate securities trades in a market in the countries of the other dealers.

25. The system of claim 24, being further programmed to provide quotes for securities traded on markets in each of the dealers' countries for clients of the other allied securities dealers.

26. The system of claim 24, being further programmed to:
maintain a custodial account for securities traded on a securities market in each dealer's country on behalf of clients of the other dealers.

27. The system of claim 24, being further programmed to provide a central computer memory from which the allied securities dealers may retrieve the shared research, and to provide a central routing service designed to implement the trade execution among the allied securities dealers.

28. The system of claim 27, being further programmed to validate a trade requested by a client of one of the allied securities dealers for compliance with market rules of the exchange on which the security is to be traded.

29. The system of claim 27, being further programmed to generate messages to the allied securities dealers to implement trade execution from order receipt to either completion or referral to an exception mechanism.

30. The system of claim 24, being further programmed to provide computer infrastructure to settle and clear trades executed by one of the allied securities dealers on behalf of clients of the other allied securities dealers.

31. The system of claim 24, being further programmed to provide computer infrastructure for currency conversion for trades executed by one of the allied securities dealers on behalf of clients of the other allied securities dealers.

32. A method, comprising the steps of:
arranging an alliance among securities dealers in at least three countries, respectively, each dealer agreeing to provide trade execution services in a securities market in the dealer's country to clients of the other dealers of the alliance, each dealer agreeing to guarantee settlement of any trade agreed in the market in the dealer's country.

33. The method of claim 32, wherein each dealer agrees to act as custodian for securities traded on a securities market in the dealer's country on behalf of clients of the other dealers in the alliance.

34. The method of claim 32, wherein each dealer agrees to guarantee settlement of trades as an absolute obligation with no defenses.

35. The method of claim 32, further comprising the step of:
including within the alliance a hub entity, independent of at least most of the allied securities dealers, the hub entity agreeing to act as counter-party for trades among the allied securities dealers, and agreeing to guarantee settlement of any trade to which it is party-party.

36. The method of claim 32, further comprising the step of:
including within the alliance a hub entity, independent of at least most of the allied securities dealers, the hub entity contracting to make a market in at least some of the securities traded by the allied securities dealers.

37. The method of claim 32, further comprising the step of:
agreeing among the dealers that each dealer is to maintain a custodial account for securities traded on a securities market in the dealer's country on behalf of clients of the other dealers.

38. The method of claim 32, further comprising the step of:
including within the alliance a hub entity, independent of at least most of the allied securities dealers, the hub entity contracting to provide computer infrastructure designed to implement clearing and settlement of trades among the allied securities dealers.

39. The method of claim 38, wherein the hub entity further contracts to provide computer infrastructure for currency conversion for trades executed by one of the allied securities dealers on behalf of clients of the other allied securities dealers.

40. A method performed by a securities dealer in a first country, comprising the steps of:
joining an alliance with at least two other securities dealers, being dealers in second and third countries, respectively, each of the three securities dealers agreeing to provide trade execution services in a securities market in the dealer's country to clients of the other dealers of the alliance, each dealer agreeing to guarantee settlement of any trade agreed in the market in the dealer's country.

41. The method of claim 40, wherein each dealer agrees to guarantee settlement of trades as an absolute obligation with no defenses.

42. The method of claim 40, further comprising the step of:
including within the alliance a hub entity, independent of at least most of the allied securities dealers, the hub entity agreeing to act as counter-party for trades among the allied securities dealers, and agreeing to guarantee settlement of any trade to which it is counter-party.

43. The method of claim 40, further comprising the step of:
including within the alliance a hub entity, independent of at least most of the allied securities dealers, the hub entity contracting to provide computer infrastructure designed to implement clearing and settlement of trades among the allied securities dealers.

44. A method, comprising the steps of:
arranging an alliance among securities dealers in at least three countries, respectively, each dealer agreeing to act as custodian for securities traded on a securities market in the dealer's country on behalf of clients of the other dealers in the alliance.

45. The method of claim 44, further comprising the step of:
including within the alliance a hub entity, independent of at least most of the allied securities dealers, the hub entity agreeing to act as counter-party for trades among the allied securities dealers.

46. The method of claim 44, further comprising the step of:
including within the alliance a hub entity, independent of at least most of the allied securities dealers, the hub entity contracting to make a market in at least some of the securities traded by the allied securities dealers.

47. The method of claim 44, further comprising the step of:
including within the alliance a hub entity, independent of at least most of the allied securities dealers, the hub entity contracting to provide computer infrastructure designed to implement clearing and settlement of trades among the allied securities dealers.

48. The method of claim 47, wherein the hub entity further contracts to provide computer infrastructure for currency conversion for trades executed by one of the allied securities dealers on behalf of clients of the other allied securities dealers.

49. A computerized system, comprising:
a computer having connections to three securities dealers in three countries, respectively, the computer system being programmed to allow each dealer to initiate securities trades in a market in the countries of the other dealers, and to maintain a custodial account at each of the securities dealers for securities traded on a securities market in the dealer's country on behalf of clients of the other dealers.
